(19) United States
(12) Patent Application Publication
(10) Pub. No.: US 2009/0214285 A1
(43) Pub. Date: Aug. 27, 2009

(54) Cosmetic holders with removable reservoir

(76) Inventor: Yong Hoon Cho, Fullerton, CA (US)

Correspondence Address: Maria Erlinda C. Sarno, Esq., P.O. Box 1023, Artesia, CA, 90702, US

(21) Appl. No.: 12/072,667

(22) Filed: Feb. 27, 2008

(51) Int. Cl. A46B 11/00; B43K 29/00

(52) U.S. Cl. 401/126; 401/119; 401/127; 401/129; 401/195

(57) ABSTRACT

A holder for cosmetic products having a hollow shell housing a removable reservoir containing a cosmetic composition. The removable reservoir is disposable or reusable. The removable reservoir comes with a replaceable applicator for the composition contained in the removable reservoir. The replaceable applicator has a handle acting as a cover for the removable reservoir. The handle inserts into an outer cover having an outside surface matching and complimenting the outside surface of the hollow shell.

The present application is related to copending application filed on the same day as this application, entitled “Carry-on Organizer” by the same inventor, Yong Hoon Cho. This application is incorporated herein by reference.

### BACKGROUND

This invention relates to a cosmetic holder with a removable reservoir that can hold liquids, suspensions and solid compositions used for cosmetic purposes. This holder is specially applicable for holding suspensions and liquids such as the mascara, nail polish, eye liner, and eye shadow compositions inside the removable reservoir.

Mascara is one of the more sellable cosmetic product and significant resources have been devoted to the improvement of the mascara product. Consequently, this product was chosen to illustrate the claimed invention.

Mascara compositions are heavy, viscous, sticky and often times, messy. One of the major problem in mascara compositions is its tendency to dry-out quickly at ambient temperature. Because of this problem, mascara holders or containers are discarded more often than other cosmetic containers. Simply for differentiation, a holder here would also refer to the final packaging of a cosmetic product without an applicator while a container would be used here to refer to the final packaging of a cosmetic product having an applicator supplied with the holder. Mascara containers are sometimes designed in a fancy manner and its cost plays a major role in the pricing of the mascara product. Reducing the number of discarded mascara containers will also help environmentally because these containers are often made of non-recyclable plastic material. For some cosmetic containers, it is not only the holders that are discarded, there is also the applicator provided with every holder that gets discarded. Further, since the mascara composition dries out easily, the container or holder has to be designed so that the opening or mouth of the holder through which the applicator is immersed, must be as small as possible which also adds to the cost of developing and manufacturing a mascara container or holder.

It is not only the mascara composition that dries out quickly. Although not as severe a problem as the mascara, nail polish, liquid eyeliner, liquid eyeshadow also have the tendency to dry out. Like the mascara product, all of these products can also be placed in a removable reservoir. Further, even cosmetics that have powder and paste compositions can be placed in a removable reservoir, not because they dry out quickly but on these, removable reservoirs are used mainly for cost effectiveness and environmental concerns. The powder and paste cosmetic compositions are usually not quick drying and do not pose the same problem as that faced with quick drying compositions like the mascara and semi-quick drying compositions like the nail polish, liquid eyeliner and liquid eyeshadow, hereinafter referred simply as quick drying compositions. Consequently, developing a removable reservoir for these is not as complex as those used for quick drying compositions. There is a need to develop a holder or a container for these quick drying cosmetic products. A removable reservoir that can be discarded or replaced while keeping the holder or container housing the removable reservoir reusable and for containers, to have the matching applicator also removable and replaceable to reduce the number of times a cosmetic container is discarded is one solution.

It is therefore an object of this invention to provide a container or holder for a cosmetic product with a quick drying composition.

It is also an object of this invention to provide a mascara product with a removable reservoir for the mascara composition.

It is also still an object of this invention to provide a nail polish product with a removable reservoir for the nail polish composition.

It is a further object of this invention to provide a cosmetic product with a removable and reusable reservoir for the quick drying compositions such as the mascara and the nail polish.

It is also a further object of this invention to provide a removable and reusable reservoir for the cosmetic products such as the mascara composition and the nail polish out of a recyclable plastic material.

It is still a further object of this invention to provide a removable reservoir that can be detached from the mascara container or holder and warmed prior to use thereby making the mascara composition less viscous and therefore easier to apply to the eyelashes.

It is also still a further object of this invention to produce a disposable or removable and replaceable mascara applicator.

### SUMMARY OF THE INVENTION

This invention relates to a cosmetic holder with a removable reservoir and a replaceable applicator to minimize the number of discarded cosmetic products. The cosmetic holder comprises a hollow shell having an outside surface and an interior compartment housing a removable reservoir, the removable reservoir containing the cosmetic composition and a replaceable applicator for the composition contained in the removable reservoir, the replaceable applicator having a handle acting as a cover for the removable reservoir, the handle inserting into an outer cover having an outside surface matching and complimenting the outside surface of the shell. With a removable reservoir and a removable and replaceable applicator, the shell and the outer cover can be preserved and reused. This provides a benefit because the shell and the outer cover complimenting it is made of a hard and sturdy material with an end finished outside surface while the removable reservoir and applicator both have unfinished outside surfaces made of inexpensive material but of a strength enough to withstand the push and pull exerted on them during the insertion and removal from the shell for the reservoir and from the outer cover for the applicator. The shell and the outer cover can have different shape, finish and design. The removable reservoir is disposable or reusable and is recommended to be made of a recyclable material. The removable reservoir engages with the shell in the same manner as the handle engages with the outer cover. There are different methods of engagement such as snap fitting, friction fitting and screw type connections. Described in detail is the engagement by snap fitting a protruding ring with a matching groove. As there are different methods of engaging the removable reservoir with the shell and the applicator with the outer cover, there are also different methods on how the handle of the applicator can cover the removable reservoir. Detailed here is a screw type connections by pairing the threading on the interior wall of the handle with the threading on the exterior top section of the removable reservoir.

While the cosmetic holder is illustrated using the mascara product and the nail polish as examples, this holder can also be applied to other cosmetic products. The removable reservoir for these products is tubular in shape to minimize the rate of dry-out of the mascara composition or the nail polish. The removable reservoir has an outside diameter slightly smaller than the inside diameter of the shell. For the mascara product, the removable reservoir has a tube cap with a tapered tip at an interior upper end of the removable reservoir to ward off excess mascara composition on the applicator head during usage. Aside from engaging the removable reservoir with the shell, a lip at a top section of the removable tubular reservoir sits on top of a peripheral top edge of the shell to prevent the removable reservoir from inserting too far into the shell and to cover any gap in space between the removable reservoir and the shell. The replaceable applicator for use with the mascara composition has a handle, a rod attached to the handle at one end and to an applicator head at another end. The most common applicator head for the mascara product is a spirally wound bristle while in a nail polish, the applicator head is a flock of straight bristles. The handle is detachable from the outer cover.

This mascara product on a holder with a removable reservoir can be sold as an independent unit or it can be incorporated or carried along with other cosmetic products or beauty implements as a single piece in a carry-on organizer. A mascara product on a carry-on organizer comprises a long cap having a hollow interior compartment fused with a short cap having a hollow interior compartment with a removable reservoir inserted into the interior compartment of the long cap which acts as a shell for the removable reservoir and an applicator for a mascara composition contained in the removable reservoir. The handle of the applicator serves as the cover for the removable reservoir. The removable reservoir engages with the long cap by snap fitting a circular protruding ring with a matching circular groove, one on an outside surface of the removable reservoir and the other on an internal compartment of the long cap or by friction fitting so long as the removable reservoir snugly fit into the interior compartment of the long cap. A second beauty implement is inserted into the internal compartment of the short cap. The mascara product can be carried with more than one beauty implement in a single piece by increasing the number of fused covers, holders and containers on the carry-on organizer.

Other embodiments of the present invention will become readily apparent to those skilled in the art from the following detailed description, wherein it shows and describes only certain embodiments of the invention by way of illustration. As will be realized, the invention is capable of other and different embodiments and its several details are capable of modification in various other respects, all without departing from the spirit and scope of the present invention. Accordingly, the drawings and detailed description are to be regarded as illustrative in nature and not as restrictive.

### BRIEF DESCRIPTION OF THE DRAWING

Aspects of the present invention are illustrated by way of example, and not by way of limitation, in the accompanying drawings, wherein:

FIG. 1 is a perspective view of a prior art mascara product showing the applicator apart from the holder.

FIG. 2 is a cross sectional view of the mascara holder showing the tube cap.

FIG. 3 is an exploded view showing the reservoir and the applicator outside of the shell.

FIG. 3A is a perspective view of a nail polish applicator and the reservoir outside of the shell.

FIG. 4 is an exploded view showing the reservoir and the replaceable applicator outside of the mascara shell and outer cover.

FIG. 5 is an exploded view of an isolated replaceable applicator with the reservoir.

FIG. 5A is a enlarged view of the shape or contour of the protruding ring.

FIG. 6 is a cross sectional view of the mascara shell showing a groove around the inner walls.

FIG. 7 is an exploded view showing the insertion of the reservoir into the shell and the tube cap into the reservoir.

FIG. 8 is an enlarged view showing the point of engagement of the reservoir with the shell.

FIG. 9 is a schematic of the attachment of the applicator handle into the interior of the outer cover.

FIG. 10 is a perspective view of the mascara product with a reservoir placed in a long cap and an eyelash curler placed in a short cap of a fused carry-on organizer allowing both cosmetic products to be carried together in one piece.

### DETAILED DESCRIPTION OF THE INVENTION

A holder for cosmetic products described herein has an outside shell having an outside surface and an interior compartment housing a removable reservoir, the removable reservoir containing the cosmetic composition. The cosmetic holder with removable reservoir will be applied here to the mascara product as the example even if this is also applicable to other cosmetic products like the nail polish, nail polish removers, liquid eyeliner, liquid eyeshadow, etc. that have a tendency to dry out when exposed or when air penetrates into the container when it is not sealed properly. A removable reservoir provides an additional advantage for the mascara product which has a mascara composition that is heavy, viscous and sticky because the reservoir, being removable, the mascara composition can be slightly warmed to render it less viscous and therefore more spreadable prior to use. Removable reservoirs can also be used for powder and paste cosmetic compositions which do not have a tendency to dry out quickly but its design and construction are not as stringent as those used for quick drying cosmetic compositions.

Mascara compositions are usually contained in cylindrical tubes or bottles of small cross sectional area to retard its dry-out. However, even with controlled geometry of the mascara holder, dry-out still occurs. Mascara compositions dry out even in an unopened holder when stored for a period of time. This has caused many mascara holders to be discarded even after little usage. Users who are hurt most are those who do not frequently apply mascara on their eyelashes and also those who use it very often because the repeated opening and immersion of the applicator into the mascara holder incorporate air into the product, thus accelerating the rate of dry-out. Consequently for rare and habitual users, both get less value for their money.

To minimize the number of discarded mascara holder, described herein is a mascara holder with a removable reservoir. The removable reservoir can be disposable, reusable and refillable. Reusable and refillable reservoirs are akin to the ink cartridges for printers, except for the shape, where they can be cleaned, refilled and reused. As shown in the drawings provided, the removable reservoir is tubular in shape to retard or minimize the dry-out of the mascara composition contained within the reservoir. Since the cover of the mascara holder is designed to match with the mascara holder and would be cost effective to also keep this, a removable and replaceable mascara applicator detachable from the cover is also a part of the improvement proposed herein. The mascara applicator is used for applying the mascara composition contained inside the removable reservoir. The removable and replaceable mascara applicator is hereinafter referred to simply as replaceable applicator. With a removable reservoir and a removable and replaceable applicator, the holder housing the removable reservoir and the cover detached from the applicator can be kept and reused over and over again thereby reducing the number of containers discarded. The mascara holder with the mascara applicator, when taken together as a cosmetic product is referred to as mascara container as stated above just to differentiate this from cosmetic products without an applicator which are also identified as cosmetic holders. However, the mascara holder housing a removable reservoir will be referred to as a shell and this shell has a matching outer cover for the replaceable mascara applicator.

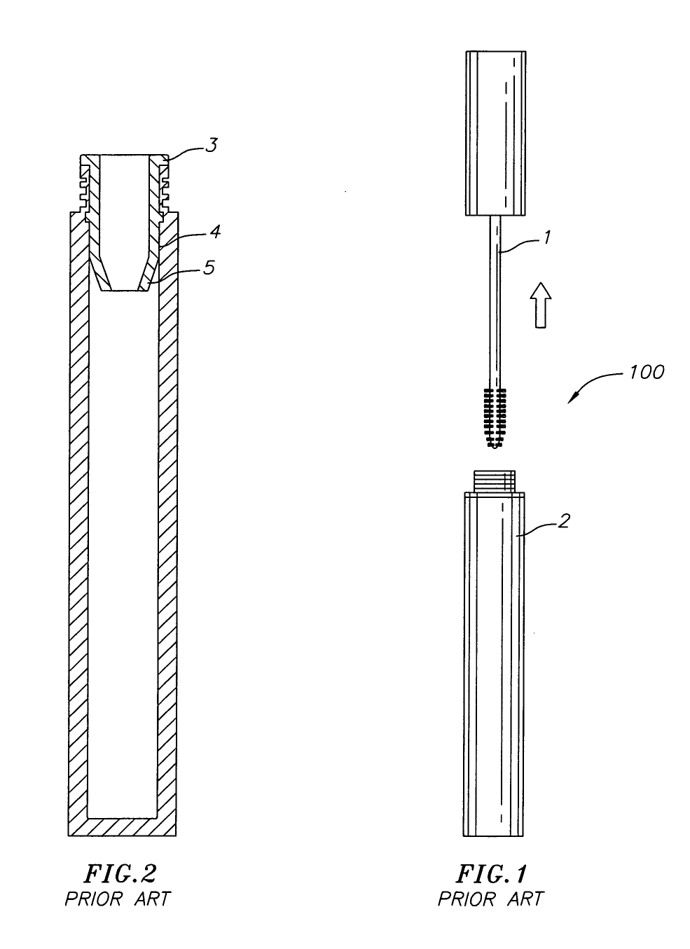

FIG. 1 shows a typical mascara product 100 having the applicator 1 exposed or apart from the holder 2. The mascara composition is housed or contained inside the interior compartment of holder 2. A tube cap 3 is placed at the interior upper end 4 of the holder 2. The tube cap has a tapered tip 5 at the end inserting into the holder 2 as shown in FIG. 2. Present mascara containers do not have a removable reservoir. Consequently, the mascara composition is placed at the interior compartment of the holder 2. However, for mascara holders with a removable reservoir, the mascara holder 2 acts as an outside shell for the removable reservoir which in this case, contains the mascara composition. The shell, like the present mascara holder, is hollow. The holder 2 housing the reservoir will hereinafter referred to as shell or shell/holder but will maintain its designation as 2. Use of the term “shell or holder” means it is applicable for both conventional holders and for the shell holding the removable reservoir.

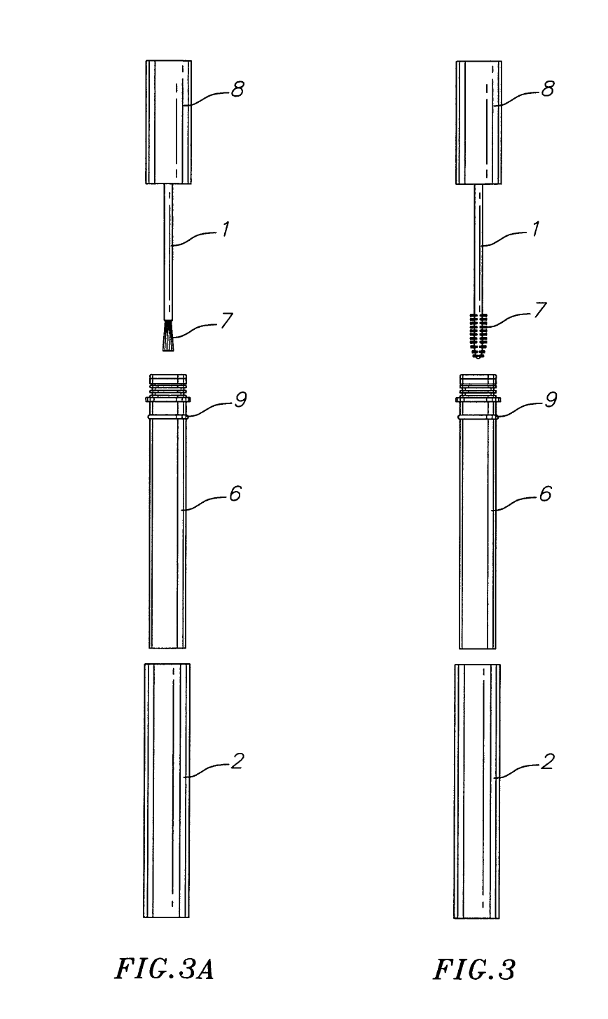

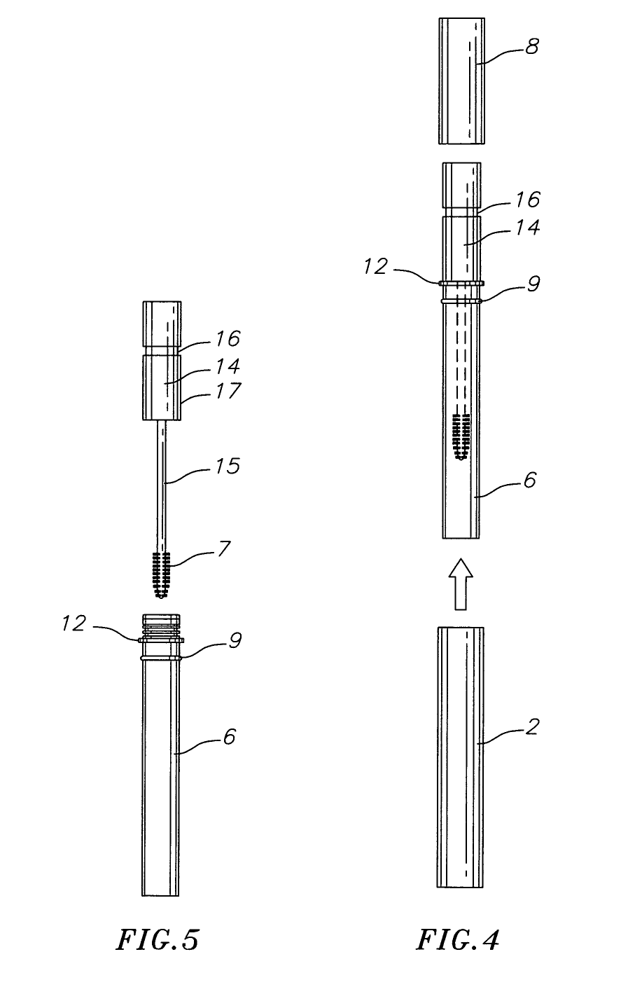

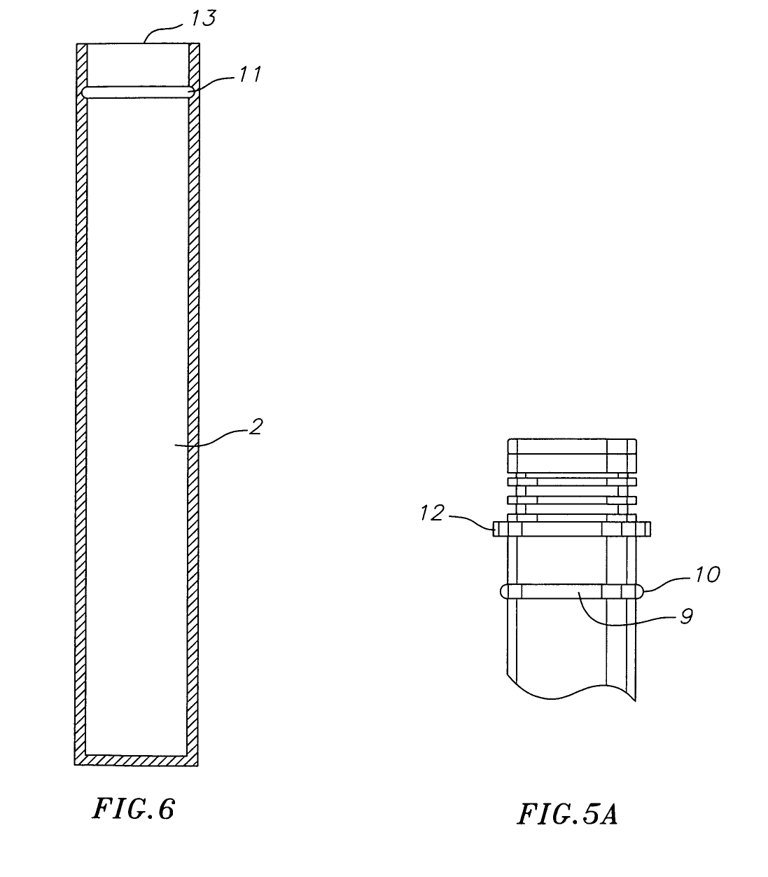

The cost of a mascara container, holder and applicator, plays a major consideration in the pricing of a mascara product. The shell or holder 2 is often made of a hard and sturdy plastic material with an end finished outside surface. End finish means the final appearance of the of the shell or holder as sold in the market. Finish includes lamination, coloring, etching, polishing, designing and the like done on the outside surface of the holder or shell. Although FIG. 1 shows a straight plain tubular design, mascara shells and holders 2 come in different shape, finish, and design. Some mascara shells or holders are even made from expensive metals. In contrast, a removable reservoir 6 for the mascara composition which can be disposable or reusable, hereinafter also referred to simply as reservoir unless distinction in function is needed, is usually made of an inexpensive material like plastic or aluminum with an unfinished outside surface, but of a strength enough to withstand the push and pull exerted on the reservoir during insertion and removal. To preserve or keep from discarding the mascara shells or holders, the reservoir is inserted into the internal compartment of the shell such that when the mascara composition dries out, only the reservoir 6 is removed, either discarded or cleaned and refilled before it is placed back to the shell 2 for reuse. The reservoir 6 can also be made of a recyclable plastic material because this does not need to be as thick, hard and sturdy as the shell or holder 2. An inexpensive metallic material can also be used such as aluminum which is also recyclable. These materials however, should be chemically compatible with the mascara composition especially considering the solvent used in the formulation. If the material from which the reservoir is made is inexpensive, the reservoir is usually discarded instead of being cleaned and refilled for use. Also, there are times when a lot of mascara composition deposits into the applicator head such as within the spirally wound bristles or brush 7, which is the most common applicator head. These deposits renders the applicator unusable or unsuitable for eyelashes because this requires even distribution of the mascara composition on the eyelashes. A replaceable applicator 1 would find most usage in these situations. The replaceable mascara applicator 1 has a handle which also acts as the cover for the removable reservoir as shown in FIGS. 4 and 5. The mascara applicator is designed similarly for the other cosmetic products, for example, with the nail polish applicator, the only major differences lie on the applicator head and the interior compartment of the reservoir. In the mascara applicator, the head 7 is usually a spirally wound bristle or brush as shown in FIG. 3 while in the nail polish applicator, the applicator head 7 is a flock of straight bristles as shown in FIG. 3A. The internal compartment of the reservoir used for a nail polish does not have the tube cap 3. The replaceable mascara applicator has a handle which also acts as a cover for the reservoir as shown in FIG. 4.

FIGS. 3 and 4 shows the cosmetic holder or container suitable for a mascara product. FIG. 3 is a perspective view of a mascara holder 2 with the removable reservoir 6. The holder 2 housing the reservoir will be referred to as shell but will maintain its identification as 2. The number identification is preserved when pointing to the same or equivalent parts or component. The reservoir 6 is tubular in shape of a small cross sectional area to retard the dry-out of the component. The outside diameter of the reservoir 6 is slightly smaller than the inside diameter of the shell 2, just enough to easily remove from and replace the reservoir into the internal compartment of the hollow cylindrical shell 2. FIG. 4 is an exploded view showing the reservoir 6 outside of the shell 2 engaged with the replaceable applicator 1 having a handle detached from an outer cover 8. A replaceable applicator when held by its own handle, the entire handle is inserted into the outer cover 8 which like the holder 2 also acts as a shell for the applicator handle.

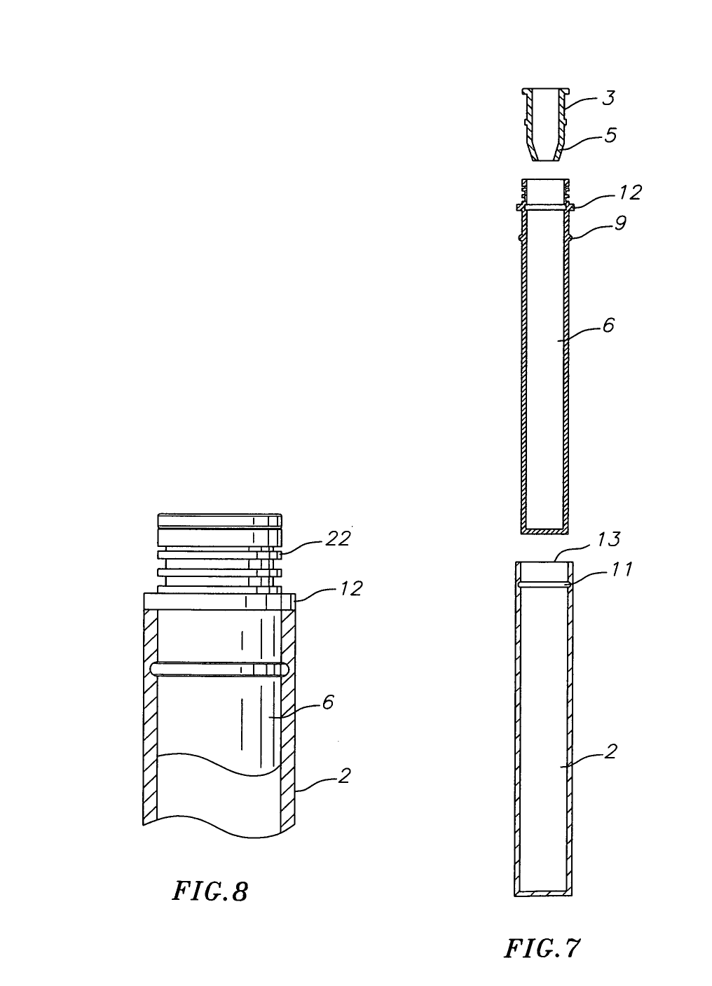

To be able to insert and remove the reservoir 6 from the shell 2, there should be a means for engaging the reservoir to the shell that will allow repeated insertion and removal. One method shown in FIGS. 3, 4, 5 and 6, is to put a circular protruding rib or ring 9 around the outside surface of the reservoir 6. This protruding ring should have sloping or rounded sides 10 to facilitate the insertion and removal but should also have just enough height to secure the protruding ring 9 inside a matching circular groove 11 (shown clearly on FIG. 6) at the inner surface of the shell 2 after engaging the reservoir with the shell. A height of approximately 0.3 mm has been found sufficient to keep the reservoir engaged with the shell and at the same time allow removal of the reservoir from the holder by exerting a pulling force on the reservoir. As shown in FIGS. 4, 6 and 8, a reservoir 6 is inserted into the shell 2 until the protruding ring 9 engages with the matching circular groove 11 at the inner surface of the shell. The position of the groove and the ring can be reversed, that is, the groove can be placed at the outside surface of the reservoir while the protruding ring can be placed at the inner surface of the shell. After insertion, lip 12 located at a top section of the tubular removable reservoir above the protruding ring 9 should sit on top of the top peripheral edge 13 of the shell 2 as shown on FIGS. 7 and 8. Because the mascara composition is placed inside the reservoir 6, the tube cap 3 is placed inside the reservoir and not inside the shell 2. A tube cap 3 is placed at the interior top end of the reservoir (on the holder for current mascara holders) to remove or ward off any excessive mascara composition on the applicator head 7 as the applicator 1 exits the reservoir by passage of the applicator head through the tapered end 5 if S the tube cap 3. Although shown and recommended here is the engagement of the reservoir with the shell by snap fitting, other known means of engagement can be used such as matching female and male threading on the reservoir and the shell for screw type connections. Friction fit is also possible but slight variation on the diameter of the outside surface of the reservoir will not firmly secure the reservoir inside the shell. The reservoir will either be loosely retained or will fall off if the dimensions of the engaging outside surfaces vary.

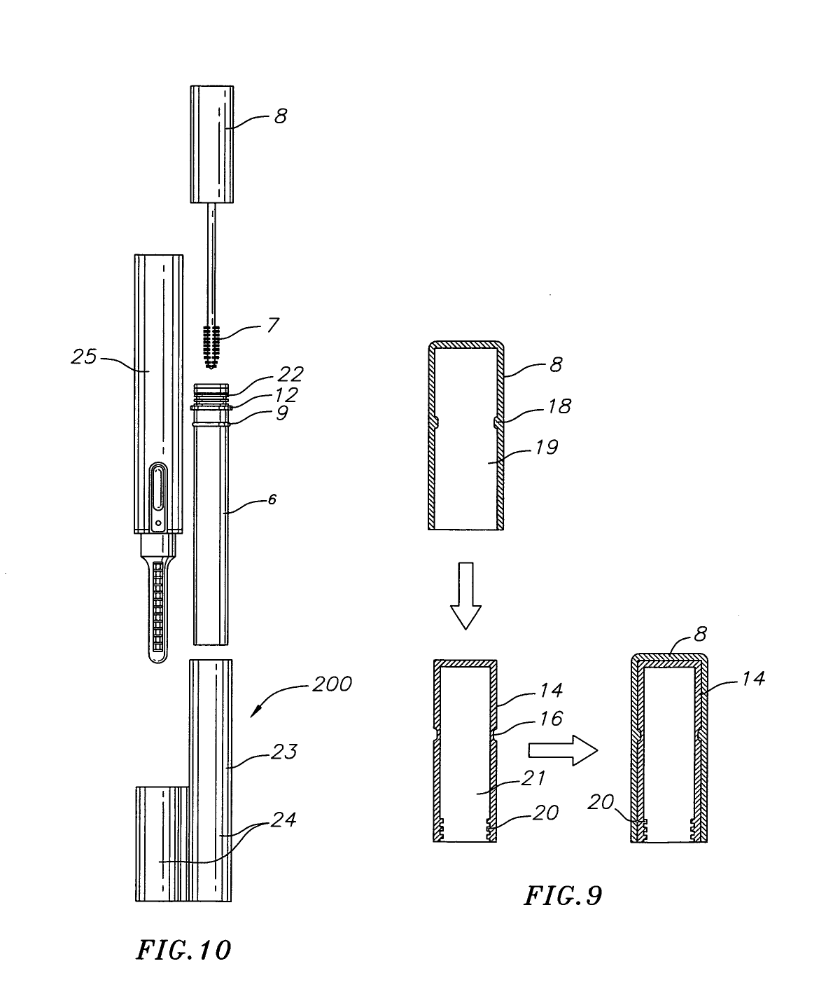

The replaceable applicator 1 comprises a handle 14, a rod 15 attached to the handle at one end and to an eyelash applicator head 7 on the other end. The handle inserts into an outer cover. The mechanism for removal and insertion of the handle 14 into the outer cover 8 is similar to the methods of engaging the reservoir with the shell as described above. As shown in FIGS. 4, 5, and 9, however, the groove 16 is at the outside surface 17 of the handle 14 while the matching protruding rib or ring 18 is at the inner surface 19 of the outer cover 8, a reverse positioning from that shown for the reservoir and the shell which as stated above can also be designed similarly. Likewise, as in the reservoir, the protruding ring 18 can be placed at the outside surface 17 of the handle 14 and the groove 16 at the inner surface 19 of the outer cover 8. The handle 14 as shown in FIG. 9 engages with the outer cover by inserting and snapping into place the protruding ring on the cover with the groove at the handle through the ring and groove mechanism described above. The rod connects or is engaged at the interior of the handle by means known in the art. The point of attachment of the rod to the interior of the handle is above the threading 20. The outer surface of the outer cover should match and compliment the outer surface of the shell after the replaceable applicator covers the shell. Both should match not only with the dimensions of the outside surface but likewise in shape, finish, and design. Shown here is attachment by a screw type mechanism. A screw type connection is recommended to cover or secure the reservoir with the removable applicator. The threading 20 at the inside surface 21 of the handle 14 screws into a matching threading 22 on the top exterior section of the reservoir shown in FIGS. 8 and 10. Other means of securing the applicator to the reservoir can be devised.

This mascara product 100 with a reservoir can be sold as an independent unit or it can be incorporated or carried along with other cosmetic products or beauty implements as a single piece in a carry-on organizer 200. The carry-on organizer comprise of fused covers, holders and containers in any number of combinations or with the carry-on organizers made of all fused covers, all fused holders, or all fused containers, these with varying or the same lengths and internal dimensions. The detailed description of the carry-on organizer is the subject of a separate patent application filed concurrently with this application by the same inventor which is incorporated herein by reference. The mascara product with a reservoir and replaceable applicator described above in a carry-on organizer is shown in FIG. 10 with an eyelash curler 25. These two are complimentary because they are usually used hand in hand. The carry-on organizer 200 shown here is a fused cover 23 in the form of a long and short cap 24 as described in detail at the carry-on organizer application. With a mascara product having a removable reservoir 6, the design and construction of the carry-on organizer is made simpler. In the current mascara product, a holder designed to receive an applicator should be fused with the other components of the organizer, that is, with the covers, holders and containers, thereby requiring the conversion of a simple long cap 24 into the typical current mascara holder 2 having the connector and the tube cap. With the mascara composition inside the reservoir instead of the holder as described above, the reservoir can be inserted into and engaged with the long open cap 24 as shown in FIG. 10 according to the methods of engagement described above. The long cap here is the equivalent of the hollow shell and the reservoir is inserted into the internal compartment of the long cap. Doing away with the need to convert a long cap into a typical mascara holder amounts to more savings. Also, as described in the carry-on organizer application, these mascara products can be carried with more than one cosmetic products and beauty implements other than or in addition to the eyelash curler by increasing the number of fused covers, holders and containers. The description of the shell, the reservoir, the replaceable applicator with an outer cover as well as the method of engagement of the mascara reservoir with the replaceable applicator is the same and will not be reiterated.

While the embodiments of the present invention have been described, it should be understood that various changes, adaptations, and modifications may be made therein without departing from the spirit of the invention and the scope of the claims.

I claim:

1. A holder for cosmetic products, comprising:
a hollow shell having an outside surface and an interior compartment housing a removable reservoir, the removable reservoir containing the cosmetic composition;
a replaceable applicator for the composition contained in the removable reservoir, the replaceable applicator having a handle acting as a cover for the removable reservoir, the handle inserting into an outer cover having an outside surface matching and complimenting the outside surface of the shell;
means for covering the removable reservoir with the replaceable applicator;
means for engaging the removable reservoir with the shell; and,
means for engaging the replaceable applicator with the outer cover.

2. The holder of claim 1 wherein the shell and the outer cover are of different shape, finish and design.

3. The holder of claim 1 wherein the removable reservoir is disposable or reusable.

4. The holder of claim 1 wherein the removable reservoir is made of a recyclable material.

5. The holder of claim 1 wherein the means for engaging the removable reservoir with the shell and the means for engaging the replaceable applicator with the outer cover is by snap fitting a circular protruding ring with a matching circular groove.

6. The holder of claim 1 wherein the means for engaging the removable reservoir with the shell and the means for engaging the replaceable applicator with the outer cover is by friction fitting the removable reservoir into the shell and the replaceable applicator into the outer cover.

7. The holder of claim 1 wherein the means for engaging the removable reservoir with the shell and the means for engaging the replaceable applicator with the outer cover is by a matching male and female threading for a screw type connection.

8. The holder of claim 1 wherein the means for covering the removable reservoir with the replaceable applicator is a screw type connection.

9. The holder of claim 1 wherein the holder is a mascara container comprising a removable tubular reservoir housed inside the shell with an outside diameter slightly smaller than the inside diameter of the shell, having a tube cap with a tapered tip at an interior upper end of the removable reservoir, a lip at a top section of the removable tubular reservoir, the lip sitting on top of a peripheral top edge of the shell after the removable reservoir engages with the shell; a replaceable applicator for use with the mascara composition contained in the removable reservoir, the replaceable applicator having a handle, a rod attached to the handle at one end and to an applicator head at another end, the handle having a detached outer cover matching and complimenting the shell; a matching protruding ring and circular groove one on an outside surface of the reservoir and the other on an interior compartment of the hollow shell for engaging the removable reservoir with the shell; a matching protruding ring and circular groove one on an outside surface of the handle and the other on an inner surface of the outer cover for engaging the removable applicator with the outer cover; and, a threading on an inside surface of the handle and a matching threading on a top exterior section of the reservoir for covering the reservoir with the handle of the replaceable applicator through a screw type connection.

10. The holder of claim 9 wherein the shell is made of a hard and sturdy material with an end finished outside surface and the removable reservoir with an unfinished outside surface made of inexpensive material but of a strength enough to withstand the push and pull exerted on the removable reservoir during insertion and removal from the interior compartment of the shell.

11. The holder of claim 9 wherein the removable reservoir is made of a recyclable material.

12. The holder of claim 1 wherein the holder is a nail polish container comprising a removable tubular hollow reservoir housed inside the shell with an outside diameter slightly smaller than the inside diameter of the shell, a lip at a top section of the removable tubular reservoir, the lip sitting on top of the peripheral top edge of the shell after the removable reservoir engages with the shell; a replaceable applicator for use with the nail polish composition contained in the removable reservoir, the replaceable applicator having a handle, a rod attached to the handle at one end and to an applicator head at another end, the handle having a detached outer cover matching and complimenting the shell.

13. A cosmetic holder for a mascara product, comprising:
a hollow shell having an outside surface and an interior compartment housing a removable tubular reservoir with an outside diameter slightly smaller than the inside diameter of the shell, having a tube cap with a tapered tip at an interior upper end of the removable reservoir, a lip at a top section of the removable tubular reservoir, the lip sitting on top of a peripheral top edge of the shell after the removable reservoir engages with the shell;
a replaceable applicator for use with the mascara composition contained in the removable reservoir, the replaceable applicator having a handle acting as a cover for the removable reservoir, a rod attached to the handle at one end and to an applicator head at another end, the handle inserting into an outer cover having an outside surface matching and complimenting the outside surface of the shell;
a matching protruding ring and circular groove one on an outside surface of the reservoir and one on an interior compartment of the hollow shell for engaging the removable reservoir with the shell;
a matching protruding ring and circular groove one on an outside surface of the handle and one on an inner surface of the outer cover for engaging the removable applicator with the outer cover; and,
a threading on an inside surface of the handle and a matching threading on a top exterior section of the reservoir for covering the reservoir with the handle of the replaceable applicator through a screw type connection.

14. The holder of claim 13 wherein the shell and the outer cover are of different shape, finish and design.

15. The holder of claim 13 wherein the removable reservoir is disposable or reusable.

16. The holder of claim 13 wherein the removable reservoir is made of a recyclable material.

17. A mascara product on a carry-on organizer, comprising:
a long cap having a hollow interior compartment fused with a short cap having a hollow interior compartment;
a removable reservoir inserted into the interior compartment of the long cap, the long cap acting as a shell for the removable reservoir, the removable reservoir engaging with the long cap by snap fitting a circular protruding ring with a matching circular groove one on an outside surface of the removable reservoir and one on the internal compartment of the long cap;
an applicator for a mascara composition contained in the removable reservoir, the applicator having a handle serving as a cover for the removable reservoir; and,
a second beauty implement inserted into the internal compartment of the short cap.

18. The mascara product on a carry-on organizer of claim 17 further comprising covers, holders and containers fused with the long cap and the short cap for carrying more than two beauty implements along with the mascara product.
